(19) United States
(12) Patent Application Publication
(10) Pub. No.: US 2025/0135445 A1
(43) Pub. Date: May 1, 2025

(54) MAIN CATALYST FOR PREPARING POLY(4-METHYL-1-PENTENE) AND USE OF MAIN CATALYST

(71) Applicant: PetroChina Company Limited, Beijing (CN)

(72) Inventors: He REN, Beijing (CN); Yuru WANG, Beijing (CN); Yuxin GAO, Beijing (CN); Shuyan HE, Beijing (CN); Shuangyang NI, Beijing (CN); Guoxing YANG, Beijing (CN); Rui ZHANG, Beijing (CN); Xinglong ZHAO, Beijing (CN); Wei WU, Beijing (CN); Deshuai WEI, Beijing (CN)

(21) Appl. No.: 19/008,436

(22) Filed: Jan. 2, 2025

Related U.S. Application Data
(63) Continuation of application No. PCT/CN2023/112711, filed on Aug. 11, 2023.

(30) Foreign Application Priority Data
Sep. 8, 2022 (CN) 202211099369.3

(51) Int. Cl. B01J 31/18; B01J 37/00; C08F 4/76; C08F 10/14

(52) U.S. Cl. CPC B01J 31/1805; B01J 37/00; C08F 4/76; C08F 10/14; B01J 2231/12; B01J 2531/0238; B01J 2531/49

(57) ABSTRACT

The present application provides a main catalyst for preparing poly(4-methyl-1-pentene) and a use of the main catalyst. The main catalyst for preparing poly(4-methyl-1-pentene) of the present application has a structure represented by Formula I, in which R₁ is selected from hydrogen or phenyl, and when R₁ is selected from phenyl, R₁ is fused with a naphthalene ring in the Formula I to form an anthracene ring; and R₂ is selected from methyl or isopropyl. When the main catalyst of the present application is used in a catalytic system to catalyze homopolymerization of 4-methyl-1-pentene, the catalyst exhibits high catalytic activity, and the prepared poly(4-methyl-1-pentene) has high molecular weight, narrow molecular weight distribution and high isotacticity, and thus has broad market application prospects.

### CROSS-REFERENCE TO RELATED APPLICATION

This application is a continuation of International Application No. PCT/CN2023/112711, filed on Aug. 11, 2023, which claims priority to Chinese Patent Application No. 202211099369.3, filed on Sep. 8, 2022 with China National Intellectual Property Administration. Both of the aforementioned applications are hereby incorporated by reference in their entireties.

### TECHNICAL FIELD

Embodiments of the present application relate to the technical field of olefin polymerization and, in particular, to a main catalyst for preparing poly(4-methyl-1-pentene) and use of the main catalyst.

### BACKGROUND

Poly(4-methyl-1-pentene) (PMP) is a crystalline resin with a stereoregular structure, and its unique structure gives it excellent chemical resistance, mechanical properties, processability, electrical insulation properties, low dielectric properties, optical properties, permeability, and easy peeling properties. Therefore, poly(4-methyl-1-pentene) has important applications in the fields of fiber materials, release materials, high-end medical materials, and electronic materials.

Poly(4-methyl-1-pentene) is mainly prepared by catalytic homopolymerization of 4-methyl-1-pentene monomer via a catalyst. Currently, there are three types of catalyst systems for catalyzing polymerization of 4-methyl-1-pentene monomer: Ziegler-Natta catalyst, metallocene catalyst, and post-transition metal nickel-palladium catalyst.

The Ziegler-Natta catalyst can effectively catalyze the polymerization of 4-methyl-1-pentene to obtain a polymer with high isotacticity and crystallinity, and furthermore, a stereoregularity of the product can be adjusted by adding an electron donor, so that the polymer has an isotacticity of more than 95% and a melting temperature of above 230° C. However, the Ziegler-Natta catalyst has multiple active centers, and the obtained polymer has a very wide molecular weight distribution, which is usually more than 10, and low molecular weight moiety thereof has poor mechanical properties. As a result, these limit its application in high-end fields.

The metallocene catalyst can also catalyze the polymerization of 4-methyl-1-pentene, but the structure of metallocene catalyst has an important influence on the isotacticity of poly(4-methyl-1-pentene). C2 symmetric titanocene/zirconocene catalyst reported at present can catalyze the polymerization of 4-methyl-1-pentene, and the isotacticity of the resulting polymer can reach more than 90%. Since the metallocene catalyst has a single metal active center, poly(4-methyl-1-pentene) prepared by the metallocene catalyst has a narrow molecular weight distribution, which is usually less than 3. However, the metallocene catalyst has a large steric hindrance, which is difficult for insertion of monomer of 4-methyl-1-pentene with large steric hindrance. The metallocene catalyst has a low activity in catalyzing 4-methyl-1-pentene, and thus is difficult to prepare a polymer with a molecular weight of more than 100,000.

The post-transition metal nickel-palladium catalyst has poor stereo controllability when used for polymerization of 4-methyl-1-pentene, and cannot obtain poly(4-methyl-1-pentene) with high isotacticity and furthermore, the post-transition metal nickel-palladium catalyst has a chain walking process during the catalytic polymerization process, which leads to complex branching of the product, obtaining an amorphous polymer, which is difficult to have practical commercial use.

Therefore, it is significant to develop a catalytic system that can prepare poly(4-methyl-1-pentene) with high molecular weight, high isotacticity, and narrow molecular weight distribution.

### SUMMARY

The present application provides a main catalyst for preparing poly(4-methyl-1-pentene) and a preparation method thereof. The main catalyst has high catalytic activity in polymerization of 4-methyl-1-pentene, and the poly(4-methyl-1-pentene) obtained by catalysis has advantages of high molecular weight, narrow molecular weight distribution and high isotacticity.

The present application also provides a catalyst for preparing poly(4-methyl-1-pentene), which is obtained by compounding the main catalyst and an activator. Since the catalyst includes the main catalyst, the catalyst has high catalytic activity, and the poly(4-methyl-1-pentene) prepared by catalysis has the advantages of high molecular weight, narrow molecular weight distribution and high isotacticity.

The present application also provides a preparation method of poly(4-methyl-1-pentene), which uses the catalyst to catalyze homopolymerization of 4-methyl-1-pentene monomer to obtain the poly(4-methyl-1-pentene). Therefore, the poly(4-methyl-1-pentene) prepared by the method has the advantages of high molecular weight, narrow molecular weight distribution, and high isotacticity.

A first aspect of the present application provides a main catalyst for preparing poly(4-methyl-1-pentene), the main catalyst having a structure represented by Formula I:

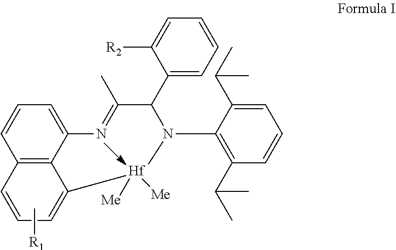

in which R₁ is selected from hydrogen or phenyl, and when R₁ is selected from phenyl, R₁ is fused with naphthalene ring in Formula I to form an anthracene ring; and R₂ is selected from methyl or isopropyl.

The compound shown in Formula I is a non-metallocene bridged imine-amido hafnium complex, the complex has a small steric hindrance, is beneficial to the coordination insertion of the 4-methyl-1-pentene monomer having a large steric hindrance, and can enable the catalyst to obtain high catalytic activity and to obtain the poly(4-methyl-1-pentene) with high molecular weight. At the same time, the complex has a single metal active center, which can enable the catalyst to have higher selectivity, and thus is beneficial to obtain the poly(4-methyl-1-pentene) with narrow molecular weight distribution and high isotacticity.

The inventor found through research that when R₂ is selected from isopropyl, the main catalyst shows higher catalytic activity, and the poly(4-methyl-1-pentene) obtained by catalysis has narrower molecular weight distribution and higher isotacticity.

A second aspect of the present application provides a preparation method of a main catalyst for preparing poly(4-methyl-1-pentene), the method having a preparation route as follows:

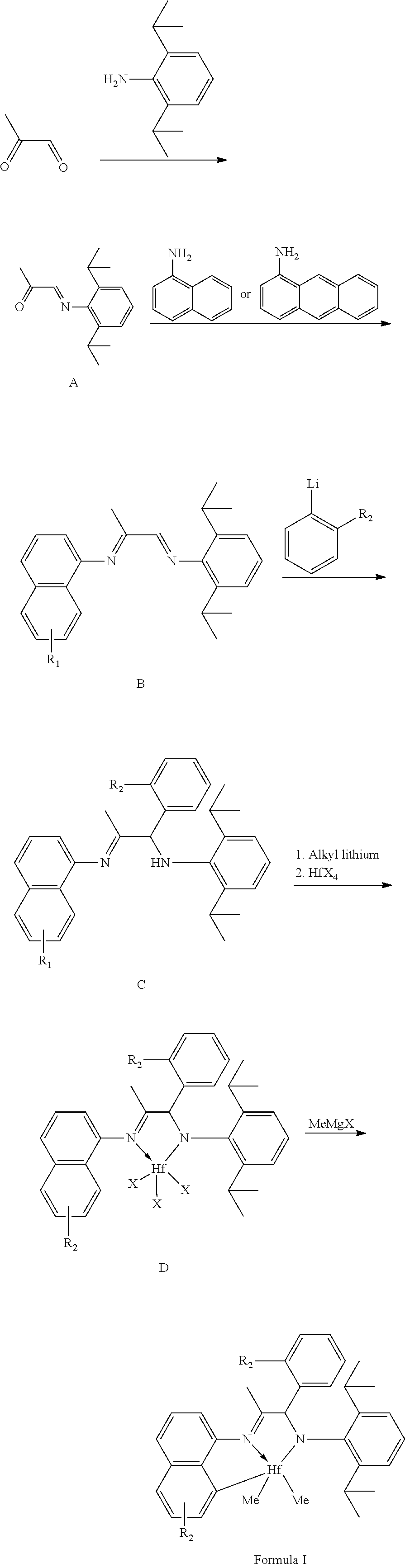

Specific steps include: 1) reacting methyl glyoxal with 2,6-diisopropylaniline to obtain an intermediate A; 2) reacting the intermediate A with α-naphthylamine or a-anthramine to obtain an intermediate B; 3) reacting the intermediate B with a R₂-displaced phenyl lithium compound to obtain an intermediate C; 4) reacting the intermediate C with an alkyl lithium and hafnium tetrahalide in sequence to obtain an intermediate D; and 5) reacting the intermediate D with methylmagnesium halide to obtain the main catalyst represented by Formula I.

Steps 1) and 2) are respectively using an aryl amine compound to condense with aldehyde group in methylglyoxal and with carbonyl group to obtain an unsymmetrical aryl-displaced diimine intermediate B; in step 3), R₂-displaced phenyl lithium compound is used as nucleophilic reagent to perform nucleophilic addition with the intermediate B to obtain the bridgehead-displaced imine-amido intermediate C, i.e., ligand of the main catalyst; in step 4), alkyl lithium removes the proton on the secondary amine, which then reacts with hafnium tetrahalide to obtain the imine-amido hafnium halide intermediate D; and in step 5), the intermediate D undergoes a Grignard reaction with methylmagnesium halide, to obtain the main catalyst represented by Formula I.

The alkyl lithium in step 4) is n-butyllithium, and hafnium tetrahalide is hafnium tetrachloride, and methylmagnesium halide in step 5) is methylmagnesium bromide.

The selection of specific reaction conditions in steps 1) to 5) is a conventional mean for those skilled with basic knowledge of organic synthesis in this field, and will not be repeated here.

A third aspect of the present application provides a catalyst for preparing poly(4-methyl-1-pentene), and the catalyst includes the main catalyst and the activator provided in the first aspect of the present application.

Due to the catalyst including the main catalyst provided in the first aspect of the present application, the catalyst has high catalytic activity, and the poly(4-methyl-1-pentene) prepared by catalysis thereof has the advantages of high molecular weight, narrow molecular weight distribution and high isotacticity.

Further, the activator of the present application is selected from a composition of trityl tetrakis (pentafluorophenyl) borate and alkyl aluminum. Where, considering the activity, selectivity and cost of the catalyst, the alkyl aluminum compound in the composition is at least one of trimethyl aluminum, triethyl aluminum and triisobutyl aluminum.

Furthermore, through experimental exploration on a molar ratio of the trityl tetrakis (pentafluorophenyl) borate to the alkyl aluminum in the composition and also a molar ratio of the main catalyst to the activator, it is found that when the molar ratio of the trityl tetrakis (pentafluorophenyl) borate to the alkyl aluminum in the composition is 1:(50-300) and the molar ratio of the main catalyst to the activator is 1:(1-5), the catalyst has higher catalytic activity, and the prepared polymer has higher molecular weight, narrower molecular weight distribution and higher isotacticity.

A fourth aspect of the present application provides a preparation method of poly(4-methyl-1-pentene), and the preparation method includes the following steps: catalyzing homopolymerization of 4-methyl-1-pentene monomer using the catalyst provided in the third aspect of the present application to obtain the poly(4-methyl-1-pentene).

The catalyst in the present application has high catalytic activity and high selectivity in the homopolymerization of 4-methyl-1-pentene, and the prepared poly(4-methyl-1-pentene) has high molecular weight, narrow molecular weight distribution and high isotacticity and shows better mechanical properties and thermal stability, having a broader market application prospect.

In the above homopolymerization, the obtained poly(4-methyl-1-pentene) can have higher molecular weight, narrower molecular weight distribution and higher isotacticity by optimizing a molar ratio of the 4-methyl-1-pentene monomer to the catalyst, a temperature of the homopolymerization, a solvent of the homopolymerization and other conditions.

After the optimization experiments, it is found that the molar ratio of the 4-methyl-1-pentene monomer to the catalyst is (100-400,000):1, or (10,000-100,000):1; the temperature of the homopolymerization is 20-60° C.; the solvent of the homopolymerization is one or more of 1,2-dichloroethane, chloroform, chlorobenzene, toluene, benzene and xylene.

By controlling a molar ratio of the 4-methyl-1-pentene monomer to the catalyst, the temperature, the solvent and other factors in the homopolymerization, the prepared poly(4-methyl-1-pentene) may have a weight average molecular weight of ≥500,000, further is 500,000-1,630,000; a molecular weight distribution index of ≤4, and further 2.0-4.0; an isotacticity of ≥95%; and a melting temperature of ≥230° C., further 230-240° C.

Compared to the prior art, the present application has at least the following beneficial effects:

1) the main catalyst provided by the present application is a non-metallocene bridged imine-amido complex, the complex has a small steric hindrance, is beneficial to the coordination insertion of the 4-methyl-1-pentene monomer having a large steric hindrance, can enable the catalyst to obtain high catalytic activity and to obtain the poly(4-methyl-1-pentene) with high molecular weight, and meanwhile, the complex has a single metal active center, which can enable the catalyst to have higher selectivity, which is beneficial to obtain the poly(4-methyl-1-pentene) with narrow molecular distribution and high isotacticity.

2) when the main catalyst of the present application is applied to a catalytic system for catalyzing the polymerization of the 4-methyl-1-pentene monomer, the poly(4-methyl-1-pentene) obtained by the polymerization has high molecular weight, narrow molecular weight distribution, high isotacticity and high melting temperature, and thus the polymer has better mechanical properties and thermal stability, and then has a broader application prospect.

3) The preparation method of the poly(4-methyl-1-pentene) provided by the present application has advantages of mild reaction conditions and high efficiency.

### BRIEF DESCRIPTION OF DRAWINGS

To describe the technical solutions in embodiments of the present application or in the prior art more clearly, the following briefly introduces the accompanying drawings needed for describing the embodiments or the prior art. Apparently, the accompanying drawings in the following description illustrate merely some embodiments of the present application, and persons of ordinary skill in the art may still derive other drawings from these accompanying drawings without creative effort.

FIG. 1 is a ¹³C NMR diagram of poly(4-methyl-1-pentene) prepared according to

Example 1.

FIG. 2 is a DSC curve of poly(4-methyl-1-pentene) prepared according to Example 1.

FIG. 3 is a GPC curve of poly(4-methyl-1-pentene) prepared according to Example 1.

### DESCRIPTION OF EMBODIMENTS

To make the objectives, technical solutions, and advantages of embodiments of the present application clearer, the following clearly and comprehensively describes the technical solutions in examples of the present application with reference to the accompanying drawings in examples of the present application. Apparently, the described examples are merely some rather than all examples of the present application. All other examples obtained by persons of ordinary skill in the art based on the examples of the present application without creative effort shall fall within the protection scope of the present application.

A main catalyst for preparing poly(4-methyl-1-pentene) provided by the present application and a use of the main catalyst will be further described in detail with reference to specific examples.

It should be noted that in the following examples, unless otherwise specified, the raw materials used are commercially available or prepared by conventional methods, and the experimental methods for which specific conditions are not indicated are all conventional methods and conventional conditions well known in this field.

A formula for calculating a catalytic activity of the catalysts in the following examples and comparative examples is: catalytic activity=mass of poly(4-methyl-1-pentene) (g)/(addition amount of main catalyst (mol)×reaction time (h).

The weight average molecular weight and the molecular weight distribution index of the poly(4-methyl-1-pentene) prepared in the following examples and comparative examples are measured by Gel Permeation Chromatography (GPC).

The melting temperature of the poly(4-methyl-1-pentene) prepared in the following examples and comparative examples are measured by Differential Scanning Calorimeter (DSC) thermal analysis method.

The isotacticity of the poly(4-methyl-1-pentene) prepared in the following examples and comparative examples are measured by ¹³C Nuclear Magnetic Resonance (NMR).

### Example 1

Preparation processes of a main catalyst, a catalyst and poly(4-methyl-1-pentene) in the present example are as follows.

### 1) Preparation of Main Catalyst P1

A preparation route is as follows:

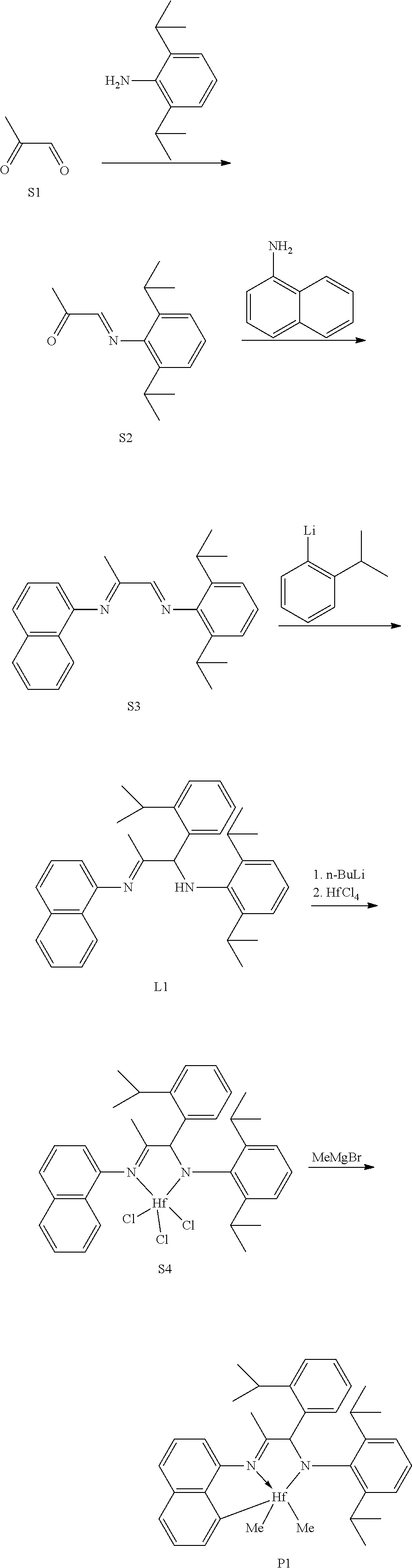

Preparation steps include:

a. adding 0.79 g (11 mmol) of a S1 (methylglyoxal), 50 mL of ethanol and a catalytic amount of formic acid into a reaction flask, mixing them evenly, then slowly dropping 1.77 g (10 mmol) of 2,6-diisopropylaniline into the reaction flask, stirring and reacting for 12 h after dropping, concentrating the reaction system to remove the solvent, and purifying the resulting concentrate by silica gel column chromatography (eluent is a mixed solvent of n-hexane and ethyl acetate with a volume ratio of 50:1), to obtain a compound S2 with a yield of 93%;

b. dissolving 0.93 g (4 mmol) of the compound S2 in 50 mL of toluene, then slowly dropping 0.72 g (5 mmol) of α-naphthylamine and a catalytic amount of p-toluenesulfonic acid, heating to reflux, reacting for 12 h, cooling, then concentrating to remove the solvent, and purifying the concentrate by column chromatography (eluent is a mixed solvent of n-hexane and ethyl acetate with a volume ratio of 50:1), to obtain a compound S3 with a yield of 89%;

c. dissolving 1.78 g (5 mmol) of the compound S3 in anhydrous ether at −40° C., slowly dropping 0.76 g (6 mmol) of a solution of 2-isopropylphenyl lithium in ether, and after dropping, naturally heating up the reaction system to room temperature and reacting overnight, and after completion of a Thin-Layer Chromatography (TLC) detection reaction, adding a saturated solution of ammonium chloride to the reaction system to quench the reaction, extracting with anhydrous ether for three times to collect an ether phase, and then washing the ether phase with a saturated saline, drying the ether phase with anhydrous sodium sulfate, filtering and concentrating in sequence, to obtain a concentrate, adding ethanol to the concentrate for recrystallization, to obtain a ligand L1 with a yield of 90%,

characterization data of the ligand L1 are as follows:

¹H NMR (CD₃Cl, 400 MHz): δ (ppm) 8.44 (d, 1H, Nap-H), 8.12-8.08 (d, 3H, Nap-H), 7.97 (d, 1H, Nap-H), 7.70-6.87 (m, 9H, Ar—H), 6.71 (s, 1H, CNH), 4.26 (s, 1H, NCH), 3.67 (sept, 2H, CH(CH₃)₂), 2.94 (sept, 1H, CH(CH₃)₂), 1.78 (d, 6H, CH(CH₃)₂), 1.19 (d, 6H, CH(CH₃)₂), 1.13 (s, 3H, C—CH₃), 1.01 (d, 3H, CH(CH₃)₂), 0.93 (d, 3H, CH(CH₃)₂),

Anal. Calcd for C₃₄H₄₀N₂: C, 85.67; H, 8.46; N, 5.88; Found: C, 85.73; H, 8.45; N, 5.82,

d. under nitrogen atmosphere, adding 0.93 g (2 mmol) of the ligand L1 to a dry Schlenk flask, adding 20 mL of toluene for dissolution, and dropping a n-butyl lithium solution (1.5 mL, 1.6 M) to the Schlenk flask at −50° C.; after dropping, naturally heating up to room temperature; after completion of the reaction, draining the solvent to precipitate a yellow powder, washing it with n-hexane for three times, and then draining n-hexane, to obtain a yellow lithium salt ligand; dissolving the yellow lithium salt ligand in toluene and transferring it to a reaction flask, adding a suspension of 0.71 g (2.2 mmol) of HfCl₄ in toluene to the reaction flask, then raising the temperature to 120° C. and reacting for 6 h, naturally cooling to room temperature, then placing the reaction flask in a low-temperature bath and cooling to −40° C.; then slowly dropping MeMgBr (2.5 mL, 3 M) into the reaction system, and after dropping, raising the temperature to room temperature and stirring for 6 h, then filtering to remove a precipitate, washing the precipitate with toluene for three times, combining filtrates and then distilling under a reduced pressure to remove the solvent in the filtrate to obtain a solid, washing the solid with n-hexane for three times and drying, to obtain the main catalyst P1, a yellow solid with a yield of 64%.

Characterization data of the main catalyst P1 are as follows:

¹H NMR (C₆D₆, 400 MHz): δ (ppm) 8.52 (d, 1H, Nap-H), 8.26 (d, 1H, Nap-H), 7.94 (d, 1H, Nap-H), 7.73 (d, 1H, Nap-H), 7.35-6.97 (m, 9H, Ar—H), 4.42 (s, 1H, NCH), 3.78 (sept, 1H, CH(CH₃)₂), 3.02 (sept, 1H, CH(CH₃)₂), 2.89 (sept, 1H, CH(CH₃)₂), 1.35 (d, 3H, CH(CH₃)₂), 1.31 (d, 3H, CH(CH₃)₂), 1.21 (d, 3H, CH(CH₃)₂), 1.17 (s, 3H, C—CH₃), 1.12 (d, 3H, CH(CH₃)₂), 0.97 (s, 3H, Hf—CH₃), 0.73 (d, 3H, CH(CH₃)₂), 0.66 (s, 3H, Hf—CH₃), 0.34 (d, 3H, CH(CH₃)₂),

MS-EI (m/z): 684.3 (M+),

Anal. Calcd for C₃₆H₄₄N₂Hf: C, 63.28; H, 6.49; N, 4.10; Found: C, 63.32; H, 6.44; N, 4.03.

### 2) Preparation of Catalyst C1-3

The compound P1 is used as a main catalyst, and a composition of trityl tetrakis (pentafluorophenyl) borate and triisobutyl aluminum (molar ratio of 1:67) is used as an activator, the activator is labeled as A3, and the main catalyst P1 is compounded with the activator A3 in a molar ratio of 1:1.5 to obtain the catalyst C1-3.

3) Preparation of poly(4-methyl-1-pentene)

Specific steps include: evacuating a Schlenk flask equipped with a magnetic stirrer continuously and baking and drying the Schlenk flask with an infrared lamp for 2 h; after natural cooling, filling nitrogen gas for three times to atmospheric pressure, and then adding 7 mL of toluene and 3 mL of 4-methyl-1-pentene monomer to the Schlenk flask in sequence, and keeping at a constant temperature of 40° C. in a water bath and stirring for half an hour; subsequently, adding 1 μmol of the catalyst C1-3 (a molar ratio of the 4-methyl-1-pentene monomer and the catalyst C1-3 is 24000:1) to the system to initiate a polymerization, and when the polymerization reaches 5 minutes, adding 10% hydrochloric acid acidified ethanol solution to terminate the polymerization, filtering the polymerization system to obtain a precipitate, washing it with ethanol for three times, drying under vacuum to a constant weight, to obtain the poly(4-methyl-1-pentene).

According to a calculation, a catalytic activity of the catalyst C1-3 in above homopolymerization is has a catalytic activity of 14.5 kg polymer/(mmol Hf·h).

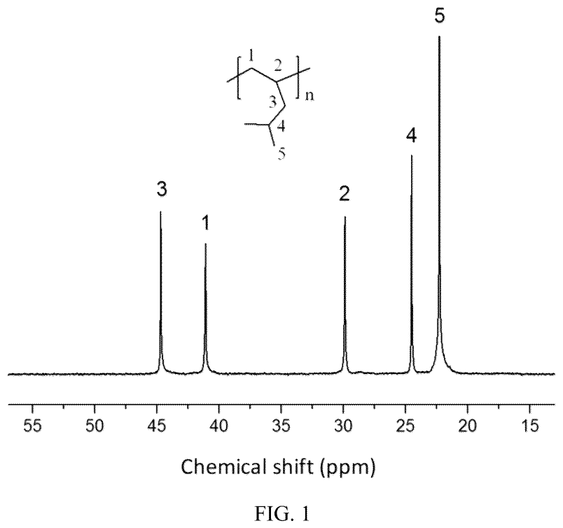

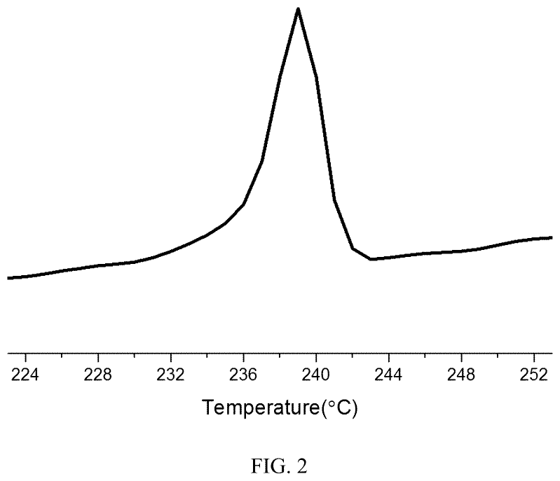

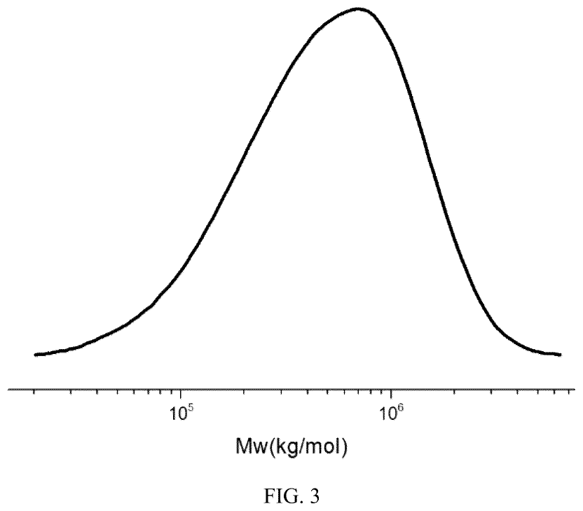

The poly(4-methyl-1-pentene) prepared in Example 1 was data characterized. FIG. 1 is a ¹³C NMR diagram of poly(4-methyl-1-pentene) prepared in Example 1; FIG. 2 is a DSC curve of poly(4-methyl-1-pentene) prepared in Example 1; FIG. 3 is a GPC curve of poly(4-methyl-1-pentene) prepared in Example 1. Through an analysis of FIGS. 1-3, it can be seen that the poly(4-methyl-1-pentene) prepared in Example 1 has a weight average molecular weight of 705 kg/mol, a molecular weight distribution index of 2.3, a melting temperature of 238° C., and an isotacticity of 98%.

### Example 2

Preparations of a main catalyst and a catalyst in the present example are the same as in Example 1; and

preparation steps of poly(4-methyl-1-pentene) in the present example are basically the same as in Example 1, with difference that the polymerization temperature is changed from 40° C. to 20° C.

In the present example, the catalyst C1-3 has a catalytic activity of 3.1 kg polymer/(mmol Hf·h), and the prepared poly(4-methyl-1-pentene) has a weight average molecular weight of 733 kg/mol, a molecular weight distribution index of 4.0, a melting temperature of 240° C., and an isotacticity of >99%.

### Example 3

Preparations of a main catalyst and a catalyst in the present example are the same as in Example 1; and

preparation steps of poly(4-methyl-1-pentene) in the present example are basically the same as in Example 1, with difference that the polymerization temperature is changed from 40° C. to 60° C.

In the present example, the catalyst C1-3 has a catalytic activity of 6.5 kg polymer/(mmol Hf·h), and the prepared poly(4-methyl-1-pentene) has a weight average molecular weight of 821 kg/mol, a molecular weight distribution index of 2.0, a melting temperature of 237° C., and an isotacticity of 97%.

### Example 4

Preparations of a main catalyst and a catalyst in the present example are the same as in Example 1; and

preparation steps of poly(4-methyl-1-pentene) in the present example are basically the same as in Example 1, with difference that the 4-methyl-1-pentene monomer added in homopolymerization is 0.0125 mL (a molar ratio of the 4-methyl-1-pentene monomer to the catalyst C1-3 is 100:1).

In the present example, the catalyst C1-3 has a catalytic activity of 4.8 kg polymer/(mmol Hf·h), and the prepared poly(4-methyl-1-pentene) has a weight average molecular weight of 501 kg/mol, a molecular weight distribution index of 2.0, a melting temperature of 239° C., and an isotacticity of 99%.

### Example 5

Preparations of a main catalyst and a catalyst in the present example are the same as in Example 1; and

preparation steps of poly(4-methyl-1-pentene) in the present example are basically the same as in Example 1, with difference that the 4-methyl-1-pentene monomer added in homopolymerization is 0.125 mL (a molar ratio of the 4-methyl-1-pentene monomer to the catalyst C1-3 is 1000:1).

In the present example, the catalyst C1-3 has a catalytic activity of 13.8 kg polymer/(mmol Hf·h), and the prepared poly(4-methyl-1-pentene) has a weight average molecular weight of 538 kg/mol, a molecular weight distribution index of 2.2, a melting temperature of 239° C., and an isotacticity of 99%.

### Example 6

Preparations of a main catalyst and a catalyst in the present example are the same as in Example 1; and

preparation steps of poly(4-methyl-1-pentene) in the present example are basically the same as in Example 1, with difference that the 4-methyl-1-pentene monomer added in homopolymerization is 1 mL (a molar ratio of the 4-methyl-1-pentene monomer to the catalyst C1-3 is 8000:1).

In the present example, the catalyst C1-3 has a catalytic activity of 9.2 kg polymer/(mmol Hf·h), and the prepared poly(4-methyl-1-pentene) has a weight average molecular weight of 686 kg/mol, a molecular weight distribution index of 2.3, a melting temperature of 238° C., and an isotacticity of 98%.

### Example 7

Preparations of a main catalyst and a catalyst in the present example are the same as in Example 1; and

preparation steps of poly(4-methyl-1-pentene) in the present example are basically the same as in Example 1, with difference that the 4-methyl-1-pentene monomer added in homopolymerization is 5 mL (a molar ratio of the 4-methyl-1-pentene monomer to the catalyst C1-3 is 40000:1).

In the present example, the catalyst C1-3 has a catalytic activity of 29.6 kg polymer/(mmol Hf·h), and the prepared poly(4-methyl-1-pentene) has a weight average molecular weight of 830 kg/mol, a molecular weight distribution index of 2.7, a melting temperature of 238° C., and an isotacticity of 98%.

### Example 8

Preparations of a main catalyst and a catalyst in the present example are the same as in Example 1; and

preparation steps of poly(4-methyl-1-pentene) in the present example are basically the same as in Example 1, with difference that the polymerization solvent is changed from toluene to benzene.

In the present example, the catalyst C1-3 has a catalytic activity of 8.3 kg polymer/(mmol Hf·h), and the prepared poly(4-methyl-1-pentene) has a weight average molecular weight of 811 kg/mol, a molecular weight distribution index of 2.7, a melting temperature of 238° C., and an isotacticity of 98%.

### Example 9

Preparations of a main catalyst and a catalyst in the present example are the same as in Example 1; and

preparation steps of poly(4-methyl-1-pentene) in the present example are basically the same as in Example 1, with difference that the polymerization solvent is changed from toluene to xylene.

In the present example, the catalyst C1-3 has a catalytic activity of 10.5 kg polymer/(mmol Hf·h), and the prepared poly(4-methyl-1-pentene) has a weight average molecular weight of 785 kg/mol, a molecular weight distribution index of 2.7, a melting temperature of 238° C., and an isotacticity of 98%.

### Example 10

Preparations of a main catalyst and a catalyst in the present example are the same as in Example 1; and

preparation steps of poly(4-methyl-1-pentene) in the present example are basically the same as in Example 1, with difference that the polymerization solvent is changed from toluene to 1,2-dichloroethane.

In the present example, the catalyst C1-3 has a catalytic activity of 12.1 kg polymer/(mmol Hf·h), and the prepared poly(4-methyl-1-pentene) has a weight average molecular weight of 738 kg/mol, a molecular weight distribution index of 2.6, a melting temperature of 237° C., and an isotacticity of 97%.

### Example 11

Preparations of a main catalyst and a catalyst in the present example are the same as in Example 1; and

preparation steps of poly(4-methyl-1-pentene) in the present example are basically the same as in Example 1, with difference that the polymerization solvent is changed from toluene to chloroform.

In the present example, the catalyst C1-3 has a catalytic activity of 9.8 kg polymer/(mmol Hf·h), and the prepared poly(4-methyl-1-pentene) has a weight average molecular weight of 765 kg/mol, a molecular weight distribution index of 2.6, a melting temperature of 237° C., and an isotacticity of 97%.

### Example 12

Preparations of a main catalyst and a catalyst in the present example are the same as in Example 1; and

preparation steps of poly(4-methyl-1-pentene) in the present example are basically the same as in Example 1, with difference that the polymerization solvent is changed from toluene to chlorobenzene.

In the present example, the catalyst C1-3 has a catalytic activity of 10.9 kg polymer/(mmol Hf·h), and the prepared poly(4-methyl-1-pentene) has a weight average molecular weight of 857 kg/mol, a molecular weight distribution index of 2.7, a melting temperature of 238° C., and an isotacticity of 98%.

### Example 13

Preparations of a main catalyst and a catalyst in the present example are the same as in Example 1; and

preparation steps of poly(4-methyl-1-pentene) in the present example are basically the same as in Example 1, with difference that the polymerization solvent is changed from toluene to a mixed solvent of toluene and benzene with a volume ratio of 1:1.

In the present example, the catalyst C1-3 has a catalytic activity of 7.8 kg polymer/(mmol Hf·h), and the prepared poly(4-methyl-1-pentene) has a weight average molecular weight of 778 kg/mol, a molecular weight distribution index of 2.7, a melting temperature of 238° C., and an isotacticity of 98%.

### Example 14

Preparations of a main catalyst and a catalyst in the present example are the same as in Example 1; and

preparation steps of poly(4-methyl-1-pentene) in the present example are basically the same as in Example 1, with difference that the polymerization solvent is changed from toluene to a mixed solvent of toluene and xylene with a volume ratio of 1:1.

In the present example, the catalyst C1-3 has a catalytic activity of 8.7 kg polymer/(mmol Hf·h), and the prepared poly(4-methyl-1-pentene) has a weight average molecular weight of 749 kg/mol, a molecular weight distribution index of 2.7, a melting temperature of 238° C., and an isotacticity of 98%.

### Example 15

Preparations of a main catalyst and a catalyst in the present example are the same as in Example 1; and

preparation steps of poly(4-methyl-1-pentene) in the present example are basically the same as in Example 1, with difference that the polymerization solvent is changed from toluene to a mixed solvent of 1,2-dichloroethane and chloroform with a volume ratio of 1:1.

In the present example, the catalyst C1-3 has a catalytic activity of 7.1 kg polymer/(mmol Hf·h), and the prepared poly(4-methyl-1-pentene) has a weight average molecular weight of 794 kg/mol, a molecular weight distribution index of 2.6, a melting temperature of 237° C., and an isotacticity of 97%.

### Example 16

Preparations of a main catalyst and a catalyst in the present example are the same as in Example 1; and

preparation steps of poly(4-methyl-1-pentene) in the present example are basically the same as in Example 1, with difference that the polymerization solvent is changed from toluene to a mixed solvent of chlorobenzene and benzene with a volume ratio of 1:1.

In the present example, the catalyst C1-3 has a catalytic activity of 8.1 kg polymer/(mmol Hf·h), and the prepared poly(4-methyl-1-pentene) has a weight average molecular weight of 843 kg/mol, a molecular weight distribution index of 2.7, a melting temperature of 238° C., and an isotacticity of 98%.

### Example 17

A main catalyst of the present example is the same as that in Example 1;

a catalyst in the present example is obtained by compounding the main catalyst P1 with the activator A3 in a molar ratio of 1:1, and the obtained catalyst is labeled as catalyst C1-7; and

preparation steps of poly(4-methyl-1-pentene) in the present example are basically the same as in Example 1, with difference that the catalyst C1-3 is replaced with the catalyst C1-7.

In the present example, the catalyst C1-7 has a catalytic activity of 6.8 kg polymer/(mmol Hf·h), and the prepared poly(4-methyl-1-pentene) has a weight average molecular weight of 688 kg/mol, a molecular weight distribution index of 2.5, a melting temperature of 238° C., and an isotacticity of 98%.

### Example 18

A main catalyst of the present example is the same as that in Example 1;

a catalyst in the present example is obtained by compounding the main catalyst P1 with the activator A3 in a molar ratio of 1:3, and the obtained catalyst is labeled as catalyst C1-8; and

preparation steps of poly(4-methyl-1-pentene) in the present example are basically the same as in Example 1, with difference that the catalyst C1-3 is replaced with the catalyst C1-8.

In the present example, the catalyst C1-8 has a catalytic activity of 7.2 kg polymer/(mmol Hf·h), and the prepared poly(4-methyl-1-pentene) has a weight average molecular weight of 744 kg/mol, a molecular weight distribution index of 2.6, a melting temperature of 238° C., and an isotacticity of 98%.

### Example 19

A main catalyst of the present example is the same as that in Example 1;

a catalyst in the present example is obtained by compounding the main catalyst P1 with the activator A3 in a molar ratio of 1:5, and the obtained catalyst is labeled as catalyst C1-9; and

preparation steps of poly(4-methyl-1-pentene) in the present example are basically the same as in Example 1, with difference that the catalyst C1-3 is replaced with the catalyst C1-9.

In the present example, the catalyst C1-9 has a catalytic activity of 8.8 kg polymer/(mmol Hf·h), and the prepared poly(4-methyl-1-pentene) has a weight average molecular weight of 798 kg/mol, a molecular weight distribution index of 2.7, a melting temperature of 238° C., and an isotacticity of 98%.

### Example 20

A main catalyst of the present example is the same as that in Example 1;

a catalyst of the present example uses the compound P1 as a main catalyst and a composition of trityl tetrakis (pentafluorophenyl) borate and triisobutyl aluminum (molar ratio of 1:50) as an activator, the activator is labeled as A4, and the main catalyst P1 is compounded with the activator A4 in a mass ratio of 1:1.5 to obtain a catalyst C1-4; and

preparation steps of poly(4-methyl-1-pentene) in the present example are basically the same as in Example 1, with difference that the catalyst C1-3 is replaced with the catalyst C1-4.

In the present example, the catalyst C1-4 has a catalytic activity of 8.3 kg polymer/(mmol Hf·h), and the prepared poly(4-methyl-1-pentene) has a weight average molecular weight of 667 kg/mol, a molecular weight distribution index of 2.8, a melting temperature of 238° C., and an isotacticity of 98%.

### Example 21

A main catalyst of the present example is the same as that in Example 1;

a catalyst of the present example uses the compound P1 as a main catalyst and a composition of trityl tetrakis (pentafluorophenyl) borate and triisobutyl aluminum (molar ratio of 1:150) as an activator, the activator is labeled as A5, and the main catalyst P1 is compounded with the activator A5 in a mass ratio of 1:1.5 to obtain a catalyst C1-5; and

preparation steps of poly(4-methyl-1-pentene) in the present example are basically the same as in Example 1, with difference that the catalyst C1-3 is replaced with the catalyst C1-5.

In the present example, the catalyst C1-5 has a catalytic activity of 8.9 kg polymer/(mmol Hf·h), and the prepared poly(4-methyl-1-pentene) has a weight average molecular weight of 601 kg/mol, a molecular weight distribution index of 3.0, a melting temperature of 238° C., and an isotacticity of 98%.

### Example 22

A main catalyst of the present example is the same as that in Example 1;

a catalyst of the present example uses the compound P1 as a main catalyst and a composition of trityl tetrakis (pentafluorophenyl) borate and triisobutyl aluminum (molar ratio of 1:300) as an activator, the activator is labeled as A6, and the main catalyst P1 is compounded with the activator A6 in a mass ratio of 1:1.5 to obtain a catalyst C1-6; and preparation steps of poly(4-methyl-1-pentene) in the present example are basically the same as in Example 1, with difference that the catalyst C1-3 is replaced with the catalyst C1-6.

In the present example, the catalyst C1-6 has a catalytic activity of 7.4 kg polymer/(mmol Hf·h), and the prepared poly(4-methyl-1-pentene) has a weight average molecular weight of 519 kg/mol, a molecular weight distribution index of 3.5, a melting temperature of 238° C., and an isotacticity of 98%.

### Example 23

A main catalyst of the present example is the same as that in Example 1;

a catalyst of the present example uses the compound P1 as a main catalyst and a composition of trityl tetrakis (pentafluorophenyl) borate and trimethyl aluminum (molar ratio of 1:67) as an activator, the activator is labeled as A1, and the main catalyst P1 is compounded with the activator Al in a mass ratio of 1:1.5 to obtain a catalyst C1-1; and

preparation steps of poly(4-methyl-1-pentene) in the present example are basically the same as in Example 1, with difference that the catalyst C1-3 is replaced with the catalyst C1-1.

In the present example, the catalyst C1-1 has a catalytic activity of 7.8 kg polymer/(mmol Hf·h), and the prepared poly(4-methyl-1-pentene) has a weight average molecular weight of 556 kg/mol, a molecular weight distribution index of 3.0, a melting temperature of 238° C., and an isotacticity of 98%.

### Example 24

A main catalyst of the present example is the same as that in Example 1;

a catalyst of the present example uses the compound P1 as a main catalyst and a composition of trityl tetrakis (pentafluorophenyl) borate and triethyl aluminum (molar ratio of 1:67) as an activator, the activator is labeled as A2, and the main catalyst P1 is compounded with the activator A2 in a mass ratio of 1:1.5 to obtain a catalyst C1-2; and

preparation steps of poly(4-methyl-1-pentene) in the present example are basically the same as in Example 1, with difference that the catalyst C1-3 is replaced with the catalyst C1-2.

In the present example, the catalyst C1-2 has a catalytic activity of 9.4 kg polymer/(mmol Hf·h), and the prepared poly(4-methyl-1-pentene) has a weight average molecular weight of 618 kg/mol, a molecular weight distribution index of 2.8, a melting temperature of 238° C., and an isotacticity of 98%.

### Example 25

Preparation processes of a main catalyst, a catalyst and poly(4-methyl-1-pentene) in the present example are as follows.

### 1) Preparation of Main Catalyst P2

The main catalyst P2 has a structural formula as shown below:

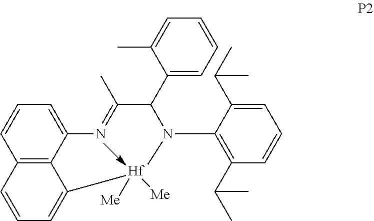

Preparation steps of the main catalyst P2 are basically the same as those of the main catalyst P1 described in Example 1, with difference that the 2-isopropylphenyl lithium in step c is replaced with methylphenyl lithium, and a product in step c is a ligand L2, a yield in step c is 91%, and a yield in step d is 68%.

The ligand L2 has a structural formula as shown below:

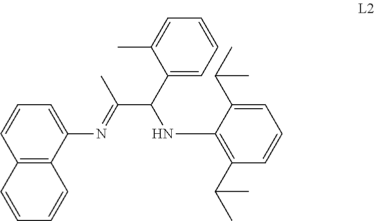 [SMILES: C/C(=N\c1cccc2ccccc12)C(Nc1c(C(C)C)cccc1C(C)C)c1ccccc1C]

Characterization data of the ligand L2 are as follows:

¹H NMR (CD₃Cl, 400 MHz): δ (ppm) 8.24 (d, 1H, Nap-H), 8.19-8.16 (d, 3H, Nap-H), 8.00 (d, 1H, Nap-H), 7.63-7.08 (m, 9H, Ar—H), 6.80 (s, 1H, CNH), 4.01 (s, 1H, NCH), 3.77 (sept, 2H, CH(CH₃)₂), 3.01 (sept, 1H, CH(CH₃)₂), 2.96 (d, 3H, C(CH₃)₂).1.78 (d, 6H, CH(CH₃)₂), 1.19 (d, 6H, CH(CH₃)₂), 1.01 (d, 3H, CH(CH₃)₂).

Anal. Calcd for C₃₂H₃₆N₂: C, 85.67; H, 8.09; N, 6.24; Found: C, 85.73; H, 8.05; N, 6.20.

Characterization data of the main catalyst P2 are as follows:

¹H NMR (C₆D₆, 400 MHz): δ (ppm) 8.42 (d, 1H, Nap-H), 8.18 (d, 1H, Nap-H), 8.05 (d, 1H, Nap-H), 7.76 (d, 1H, Nap-H), 7.41-6.99 (m, 9H, Ar—H), 4.12 (s, 1H, NCH), 3.12 (sept, 1H, CH(CH₃)₂), 2.93 (sept, 1H, CH(CH₃)₂), 2.37 (s, 3H, C—CH₃), 2.01 (s, 3H, NC—CH₃), 1.33 (d, 3H, CH(CH₃)₂), 1.21 (d, 3H, CH(CH₃)₂), 1.13 (d, 3H, CH(CH₃)₂), 0.90 (s, 3H, Hf—CH₃), 0.87 (d, 3H, CH(CH₃)₂), 0.78 (s, 3H, Hf—CH₃).

MS-EI (m/z): 656.27 (M⁺).

Anal. Calcd for C₃₄H₄₀N₂Hf: C, 62.33; H, 6.15; N, 4.28; Found: C, 62.40; H, 6.12; N, 4.25.

### 2) Preparation of Catalyst C2-3

The compound P2 is used as the main catalyst, and the main catalyst P2 is compounded with the activator A3 in a molar ratio of 1:1.5 to obtain the catalyst C2-3.

3) Preparation of poly(4-methyl-1-pentene)

Specific steps are basically the same as in Example 1, with difference that the catalyst C1-3 is replaced with the catalyst C2-3.

In the present example, the catalyst C2-3 has a catalytic activity of 0.6 kg polymer/(mmol Hf·h), and the prepared poly(4-methyl-1-pentene) has a weight average molecular weight of 1634 kg/mol, a molecular weight distribution index of 4.0, a melting temperature of 231° C., and an isotacticity of 95%.

### Example 26

Preparation processes of a main catalyst, a catalyst and poly(4-methyl-1-pentene) in the present example are as follows.

### 1) Preparation of Main Catalyst P3

The main catalyst P3 has a structural formula as shown below:

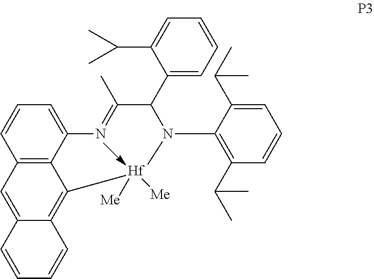

Preparation steps of the main catalyst P3 are basically the same as those of the main catalyst P1 described in Example 1, with difference that the naphthylamine in step b is replaced with anthramine; and

a ligand obtained by in step c is L3, a yield in step c is 87%, and a yield in step d is 59%.

The ligand L3 has a structural formula as shown below:

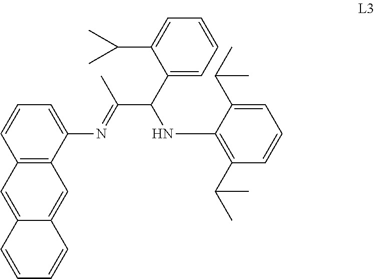 [SMILES: C/C(=N\c1cccc2cc3ccccc3cc12)C(Nc1c(C(C)C)cccc1C(C)C)c1ccccc1C(C)C]

Characterization data of the ligand L3 are as follows:

¹H NMR (C₆D₆, 400 MHz): δ (ppm) 8.49 (d, 2H, An-H), 8.21 (d, 2H, An-H), 8.13 (d, 1H, An-H), 7.68 (d, 1H, An-H), 7.49-6.95 (m, 10H, Ar—H), 6.02 (s, 1H, CNH), 4.17 (s, 1H, NCH), 3.42 (sept, 2H, CH(CH₃)₂), 2.81 (sept, 1H, CH(CH₃)₂),1.79-1.71 (d, 6H, CH(CH₃)₂), 1.23 (d, 6H, CH(CH₃)₂), 1.06 (s, 3H, C—CH₃), 1.02 (d, 3H, CH(CH₃)₂), 0.91 (d, 3H, CH(CH₃)₂).

Anal. Calcd for C₃₈H₄₂N₂: C, 86.64; H, 8.04; N, 5.32; Found: C, 86.70; H, 8.07; N, 5.35.

Characterization data of the main catalyst P3 are as follows:

¹H NMR (CD₃Cl, 400 MHz): δ (ppm) 8.58 (d, 1H, An-H), 8.41 (d, 1H, An-H), 8.13 (d, 1H, An-H), 8.02 (d, 1H, An-H), 7.64 (d, 1H, An-H), 7.49-6.84 (m, 10H, Ar—H), 4.18 (s, 1H, NCH), 3.16 (sept, 1H, CH(CH₃)₂), 2.96 (sept, 1H, CH(CH₃)₂), 2.84 (sept, 1H, CH(CH₃)₂), 1.37 (d, 3H, CH(CH₃)₂), 1.32 (d, 3H, CH(CH₃)₂), 1.20 (d, 3H, CH(CH₃)₂), 1.15 (s, 3H, C—CH₃), 1.11 (d, 3H, CH(CH₃)₂), 0.90 (s, 3H, Hf—CH₃), 0.76 (d, 3H, CH(CH₃)₂), 0.62 (s, 3H, Hf—CH₃), 0.29 (d, 3H, CH(CH₃)₂).

MS-EI (m/z): 732.31 (M⁺).

Anal. Calcd for C₄₀H₄₆N₂Hf: C, 65.52; H, 6.32; N, 3.82; Found: C, 65.59; H, 6.29; N, 3.80.

### 2) Preparation of Catalyst C3-3

The compound P3 is used as the main catalyst, and the main catalyst P3 is compounded with the activator A3 in a molar ratio of 1:1.5 to obtain the catalyst C3-3.

3) Preparation of poly(4-methyl-1-pentene)

Specific steps are basically the same as in Example 1, with difference that the catalyst C1-3 is replaced with the catalyst C3-3.

In the present example, the catalyst C3-3 has a catalytic activity of 8.3 kg polymer/(mmol Hf·h), and the prepared poly(4-methyl-1-pentene) has a weight average molecular weight of 637 kg/mol, a molecular weight distribution index of 3.0, a melting temperature of 236° C., and an isotacticity of 97%.

### Example 27

Preparation processes of a main catalyst, a catalyst and poly(4-methyl-1-pentene) in the present example are as follows.

### 1) Preparation of Main Catalyst P4

The main catalyst P4 has a structural formula as shown below:

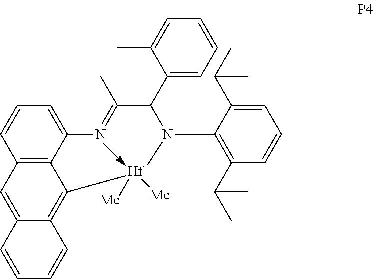

Preparation steps of the main catalyst P4 are the same as those of the main catalyst P3 described in Example 26, with difference that 2-isopropylphenyl lithium in step c is replaced with methylphenyl lithium, and a product in step c is a ligand L4, a yield in step c is 89%, and a yield in step d is 61%.

The ligand L4 has a structural formula as shown below:

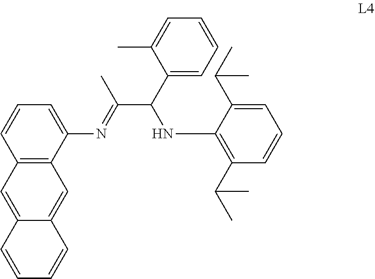 [SMILES: C/C(=N\c1cccc2cc3ccccc3cc12)C(Nc1c(C(C)C)cccc1C(C)C)c1ccccc1C]

Characterization data of the ligand L4 are as follows:

¹H NMR (CD₃Cl, 400 MHz): δ (ppm) 8.47 (d, 2H, An-H), 8.19 (d, 2H, An-H), 8.09 (d, 1H, An-H), 7.46 (d, 1H, An-H), 7.40-6.65 (m, 10H, Ar—H), 6.17 (s, 1H, CNH), 3.99 (s, 1H, NCH), 3.18 (sept, 2H, CH(CH₃)₂), 2.41 (s, 3H, C—CH₃), 1.56-1.53 (d, 6H, CH(CH₃)₂), 1.01 (s, 3H, C—CH₃), 0.97 (d, 3H, CH(CH₃)₂), 0.87 (d, 3H, CH(CH₃)₂).

Anal. Calcd for C₃₆H₃₈N₂: C, 86.70; H, 7.68; N, 5.62; Found: C, 86.74; H, 7.66; N, 5.59.

Characterization data of the main catalyst P4 are as follows:

¹H NMR (C₆D₆, 400 MHz): δ (ppm) 8.51 (d, 1H, An-H), 8.38 (d, 1H, An-H), 8.15 (d, 1H, An-H), 7.98 (d, 1H, An-H), 7.57 (d, 1H, An-H), 7.45-6.96 (m, 10H, Ar—H), 4.11 (s, 1H, NCH), 3.21 (sept, 1H, CH(CH₃)₂), 3.01 (sept, 1H, CH(CH₃)₂), 2.41 (s, 3H, C—CH₃), 2.17 (s, 3H, NC—CH₃), 1.37 (d, 3H, CH(CH₃)₂), 1.28 (d, 3H, CH(CH₃)₂), 1.13 (d, 3H, CH(CH₃)₂), 0.86 (s, 3H, Hf—CH₃), 0.81 (d, 3H, CH(CH₃)₂), 0.71 (s, 3H, Hf—CH₃).

MS-EI (m/z): 706.28 (M⁺).

Anal. Calcd for C₃₈H₄₂N₂Hf: C, 64.72; H, 6.00; N, 3.97; Found: C, 64.80; H, 6.04; N, 4.02.

### 2) Preparation of Catalyst C4-3

The compound P4 is used as the main catalyst, and the main catalyst P4 is compounded with the activator A3 in a molar ratio of 1:1.5 to obtain the catalyst C4-3.

3) Preparation of poly(4-methyl-1-pentene)

Specific steps are basically the same as in Example 1, with difference that the catalyst C1-3 is replaced with the catalyst C4-3.

In the present example, the catalyst C4-3 has a catalytic activity of 0.4 kg polymer/(mmol Hf·h), and the prepared poly(4-methyl-1-pentene) has a weight average molecular weight of 1084 kg/mol, a molecular weight distribution index of 3.8, a melting temperature of 230° C., and an isotacticity of 95%.

### Example 28

A main catalyst of the present example is the same as that in Example 1;

a catalyst of the present example uses the compound P1 as a main catalyst and a composition of trityl tetrakis (pentafluorophenyl) borate and triisobutyl aluminum (molar ratio of 1:25) as an activator, the activator is labeled as A4, and the main catalyst P1 is compounded with the activator A4 in a mass ratio of 1:1.5 to obtain a catalyst C1-10; and

preparation steps of poly(4-methyl-1-pentene) in the present example are basically the same as in Example 1, with difference that the catalyst C1-3 is replaced with the catalyst C1-10.

In the present example, the catalyst C1-10 has a catalytic activity of 9.5 kg polymer/(mmol Hf·h), and the prepared poly(4-methyl-1-pentene) has a weight average molecular weight of 345 kg/mol, a molecular weight distribution index of 2.4, a melting temperature of 238° C., and an isotacticity of 98%.

### Example 29

A main catalyst of the present example is the same as that in Example 1;

a catalyst of the present example uses the compound P1 as a main catalyst, and a composition of trityl tetrakis (pentafluorophenyl) borate and triisobutyl aluminum (molar ratio of 1:450) as an activator, the activator is labeled as A6, and the main catalyst P1 is compounded with the activator A6 in a mass ratio of 1:1.5 to obtain a catalyst C1-11; and preparation steps of poly(4-methyl-1-pentene) in the present example are basically the same as in Example 1, with difference that the catalyst C1-3 is replaced with the catalyst C1-11.

In the present example, the catalyst C1-11 has a catalytic activity of 6.9 kg polymer/(mmol Hf·h), and the prepared poly(4-methyl-1-pentene) has a weight average molecular weight of 402 kg/mol, a molecular weight distribution index of 4.0, a melting temperature of 239° C., and an isotacticity of 98%.

### Example 30

A main catalyst of the present example is the same as that in Example 1;

a catalyst in the present example is obtained by compounding the main catalyst P1 with the activator A3 in a molar ratio of 2:1, and the obtained catalyst is labeled as catalyst C1-12; and

preparation steps of poly(4-methyl-1-pentene) in the present example are basically the same as in Example 1, with difference that the catalyst C1-3 is replaced with the catalyst C1-12.

In the present example, the catalyst C1-12 has a catalytic activity of 2.9 kg polymer/(mmol Hf·h), and the prepared poly(4-methyl-1-pentene) has a weight average molecular weight of 348 kg/mol, a molecular weight distribution index of 2.3, a melting temperature of 238° C., and an isotacticity of 98%.

### Example 31

A main catalyst of the present example is the same as that in Example 1;

a catalyst in the present example is obtained by compounding the main catalyst P1 with the activator A3 in a molar ratio of 1:7, and the obtained catalyst is labeled as catalyst C1-13; and

preparation steps of poly(4-methyl-1-pentene) in the present example are basically the same as in Example 1, with difference that the catalyst C1-3 is replaced with the catalyst C1-13.

In the present example, the catalyst C1-13 has a catalytic activity of 9.9 kg polymer/(mmol Hf·h), and the prepared poly(4-methyl-1-pentene) has a weight average molecular weight of 301 kg/mol, a molecular weight distribution index of 3.0, a melting temperature of 238° C., and an isotacticity of 98%.

### Example 32

Preparations of a main catalyst and a catalyst of the present example are the same as in Example 1; and

preparation steps of poly(4-methyl-1-pentene) in the present example are basically the same as in Example 1, with difference that the 4-methyl-1-pentene monomer added in homopolymerization is 0.025 mL (a molar ratio of the 4-methyl-1-pentene monomer to the catalyst C1-3 is 200:1).

In the present example, the catalyst C1-3 has a catalytic activity of 0.6 kg polymer/(mmol Hf·h), and the prepared poly(4-methyl-1-pentene) has a weight average molecular weight of 324 kg/mol, a molecular weight distribution index of 2.0, a melting temperature of 234° C., and an isotacticity of 98%.

### Example 33

Preparations of a main catalyst and a catalyst in the present example are the same as in Example 1; and

preparation steps of poly(4-methyl-1-pentene) in the present example are basically the same as in Example 1, with difference that the 4-methyl-1-pentene monomer added in homopolymerization is 7.5 mL (a molar ratio of the 4-methyl-1-pentene monomer to the catalyst C1-3 is 60000:1).

In the present example, the catalyst C1-3 has a catalytic activity of 27.4 kg polymer/(mmol Hf·h), and the prepared poly(4-methyl-1-pentene) has a weight average molecular weight of 940 kg/mol, a molecular weight distribution index of 2.9, a melting temperature of 238° C., and an isotacticity of 97%.

### Comparative Example 1

In the present comparative example, a Ziegler-Natta catalyst (commercially obtained, product model CS-2) is used to catalyze homopolymerization of 4-methyl-1-pentene, and specific steps are as follows:

evacuating a Schlenk flask equipped with a magnetic stirrer continuously and baking and drying the Schlenk flask with an infrared lamp for 2 h, and after natural cooling, filling nitrogen gas for three times to atmospheric pressure, and then adding 7 mL of toluene, 3 mL of 4-methyl-1-pentene and 500 μmol of triethyl aluminum to the Schlenk flask in sequence, stirring and keeping at a constant temperature of 40° C. in a water bath for half an hour, adding 20 mg of the Ziegler-Nata catalyst to the reaction system to initiate a polymerization and timing, and when the polymerization reaches 2 h, opening the reaction flask, adding 10% hydrochloric acid acidified ethanol solution to terminate the polymerization, stirring for 3 h and then filtering to obtain a precipitate, washing it with ethanol for three times, drying under vacuum to a constant weight, to obtain poly(4-methyl-1-pentene).

In the present comparative example, the Ziegler-Natta catalyst has a catalytic activity of 275 g polymer/(mmol Hf·h), and the prepared poly(4-methyl-1-pentene) has a weight average molecular weight of 1004 kg/mol, a molecular weight distribution index of 13.7, a melting temperature of 237° C., and an isotacticity of 96%.

### Comparative Example 2

In the present comparative example, a zirconocene catalyst is used to catalyze homopolymerization of 4-methyl-1-pentene, and the zirconocene catalyst has a structural formula as below:

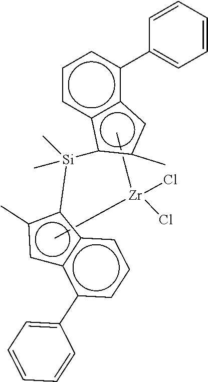

The above catalyst can be prepared by a method described in a reference J. Mol. Catal. A 1996, 112:37.

Specific steps of homopolymerization of the present comparative example are as follows: evacuating a Schlenk flask equipped with a magnetic stirrer continuously and baking and drying the Schlenk flask with an infrared lamp for 2 h, and after natural cooling, filling nitrogen gas for three times to atmospheric pressure, and then adding 7 mL of toluene, 3 mL of 4-methyl-1-pentene and 20 mmol of methylaluminoxane (MAO) to the Schlenk flask in sequence, stirring and keeping at a constant temperature of 40° C. in a water bath for half an hour, adding 10 μmol of the zirconocene catalyst to the reaction system to initiate a polymerization and timing, and when the polymerization reaches 7 h, opening the reaction flask, adding 10% hydrochloric acid acidified ethanol solution to terminate the polymerization, stirring for 3 h and then filtering to obtain a precipitate, washing it with ethanol for three times, drying under vacuum to a constant weight, to obtain poly(4-methyl-1-pentene).

In the present comparative example, the zirconocene catalyst has a catalytic activity of 10.9 g polymer/(mmol Hf·h), and the prepared poly(4-methyl-1-pentene) has a weight average molecular weight of 17 kg/mol, a molecular weight distribution index of 2.9, a melting temperature of 214° C., and an isotacticity of 90%.

### Comparative Example 3

In the present comparative example, a post-transition metal nickel catalyst is used to catalyze homopolymerization of 4-methyl-1-pentene, and the post-transition metal nickel catalyst has a structural formula as below:

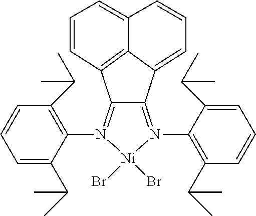

The above catalyst can be prepared by a method described in a reference Macromolecules 2000, 33, 2320.

Specific steps of homopolymerization of the present comparative example are as follows: evacuating a Schlenk flask equipped with a magnetic stirrer continuously and baking and drying the Schlenk flask with an infrared lamp for 2 h, and after natural cooling, filling nitrogen gas for three times to atmospheric pressure, and then adding 7 mL of toluene, 3 mL of 4-methyl-1-pentene and 2.5 mmol of diethylaluminum monochloride to the Schlenk flask in sequence, stirring and keeping at a constant temperature of 40° C. in a water bath for half an hour, adding 10 μmol of the post-transition metal nickel catalyst to the reaction system to initiate a polymerization and timing, and when the polymerization reaches 1 h, opening the reaction flask, adding 10% hydrochloric acid acidified ethanol solution to terminate the polymerization, stirring for 3 h and then filtering to obtain a precipitate, washing it with ethanol for three times, drying under vacuum to a constant weight, to obtain poly(4-methyl-1-pentene).

In the present comparative example, the post-transition metal nickel catalyst has a catalytic activity of 105 g polymer/(mmol Hf.h), and the prepared poly(4-methyl-1-pentene) has a weight average molecular weight of 175 kg/mol, a molecular weight distribution index of 1.5, and no melting temperature, and the resulting product is a random polymer and has an isotacticity of less than 10%.

For convenience of comparison, the catalytic activity of the catalysts prepared in the above examples and comparative examples, and values of the weight average molecular weight, the molecular weight distribution index, the melting temperature, the isotacticity and etc. of the prepared poly(4-methyl-1-pentene) are listed in Table 1.

In Table 1, in Examples 1 to 33, M in the catalytic activity unit is Hf, in Comparative example 1, M is Ti, in Comparative example 2, M is Zr, and in Comparative example 3, M is Ni.

TABLE 1

| | Catalytic | Weight average | Molecular | | |
|---|---|---|---|---|---|
| | activity/kg | molecular | weight | Melting | |
| | polymer/ | weight/ | distribution | temperature/° | |
| | (mmol M · h) | (kg/mol) | index | C. | Isotacticity/% |
| Example 1 | 14.5 | 705 | 2.3 | 238 | 98 |
| Example 2 | 3.1 | 733 | 4.0 | 240 | >99 |
| Example 3 | 6.5 | 821 | 2.0 | 237 | 97 |
| Example 4 | 4.8 | 501 | 2.0 | 239 | 99 |
| Example 5 | 13.8 | 538 | 2.2 | 239 | 99 |
| Example 6 | 9.2 | 686 | 2.3 | 238 | 98 |
| Example 7 | 29.6 | 830 | 2.7 | 238 | 98 |
| Example 8 | 8.3 | 811 | 2.7 | 238 | 98 |
| Example 9 | 10.5 | 785 | 2.7 | 238 | 98 |
| Example 10 | 12.1 | 738 | 2.6 | 237 | 97 |
| Example 11 | 9.8 | 765 | 2.6 | 237 | 97 |
| Example 12 | 10.9 | 857 | 2.7 | 238 | 98 |
| Example 13 | 7.8 | 778 | 2.7 | 238 | 98 |
| Example 14 | 8.7 | 749 | 2.7 | 238 | 98 |
| Example 15 | 7.1 | 794 | 2.6 | 237 | 97 |
| Example 16 | 8.1 | 843 | 2.7 | 238 | 98 |
| Example 17 | 6.8 | 688 | 2.5 | 238 | 98 |
| Example 18 | 7.2 | 744 | 2.6 | 238 | 98 |
| Example 19 | 8.8 | 798 | 2.7 | 238 | 98 |
| Example 20 | 8.3 | 667 | 2.8 | 238 | 98 |
| Example 21 | 8.9 | 601 | 3.0 | 238 | 98 |
| Example 22 | 7.4 | 519 | 3.5 | 238 | 98 |
| Example 23 | 7.8 | 556 | 3.0 | 238 | 98 |
| Example 24 | 9.4 | 618 | 2.8 | 238 | 98 |
| Example 25 | 0.6 | 1634 | 4.0 | 231 | 95 |
| Example 26 | 8.3 | 637 | 3.0 | 236 | 97 |
| Example 27 | 0.4 | 1084 | 3.8 | 230 | 95 |
| Example 28 | 9.5 | 345 | 2.4 | 238 | 98 |
| Example 29 | 6.9 | 402 | 4.0 | 239 | 98 |
| Example 30 | 2.9 | 348 | 2.3 | 238 | 98 |
| Example 31 | 9.9 | 301 | 3.0 | 238 | 98 |
| Example 32 | 0.6 | 324 | 2.0 | 234 | 98 |
| Example 33 | 27.4 | 940 | 2.9 | 238 | 97 |
| Comparative | 0.275 | 1004 | 13.7 | 237 | 96 |
| example 1 | | | | | |
| Comparative | 0.0109 | 17 | 2.9 | 214 | 90 |
| example 2 | | | | | |
| Comparative | 0.105 | 175 | 1.5 | / | <10 |
| example 3 | | | | | |

It can be seen from table 1, the imine-amido hafnium catalyst in the present application has higher catalytic activity compared with the Ziegler-Natta catalyst and the prepared poly(4-methyl-1-pentene) has narrower molecular weight distribution; the catalyst in the present application has higher catalytic activity compared with the zirconocene catalyst and the prepared poly(4-methyl-1-pentene) has higher molecular weight and isotacticity; and the catalyst in the present application has higher catalytic activity compared with the post-transition metal nickel catalyst, and the prepared poly(4-methyl-1-pentene) has higher isotacticity.

Finally, it should be noted that the foregoing examples are merely intended to illustrate the technical solutions of the present application other than limiting the present application. Although the present application has been described in detail with reference to the foregoing examples, persons of ordinary skill in the art should understand that they may still make modifications to the technical solutions described in the foregoing examples or make equivalent substitutions to some of or all technical features therein; but these modifications or substitutions do not make the essence of the corresponding technical solutions deviate from the scope of the technical solutions of various examples of the present application.

What is claimed is:

1. A main catalyst for preparing poly(4-methyl-1-pentene), wherein the main catalyst has a structure represented by Formula I: 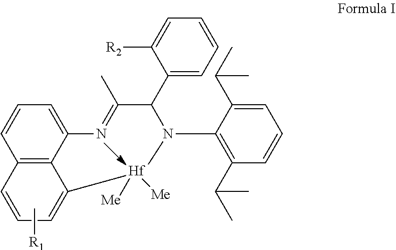
in which, R₁ is selected from hydrogen or phenyl, and when R₁ is selected from phenyl, R₁ is fused with naphthalene ring in Formula I to form an anthracene ring; and R₂ is selected from methyl or isopropyl.

2. A preparation method of the main catalyst for preparing poly(4-methyl-1-pentene) according to claim 1, comprising the following steps: 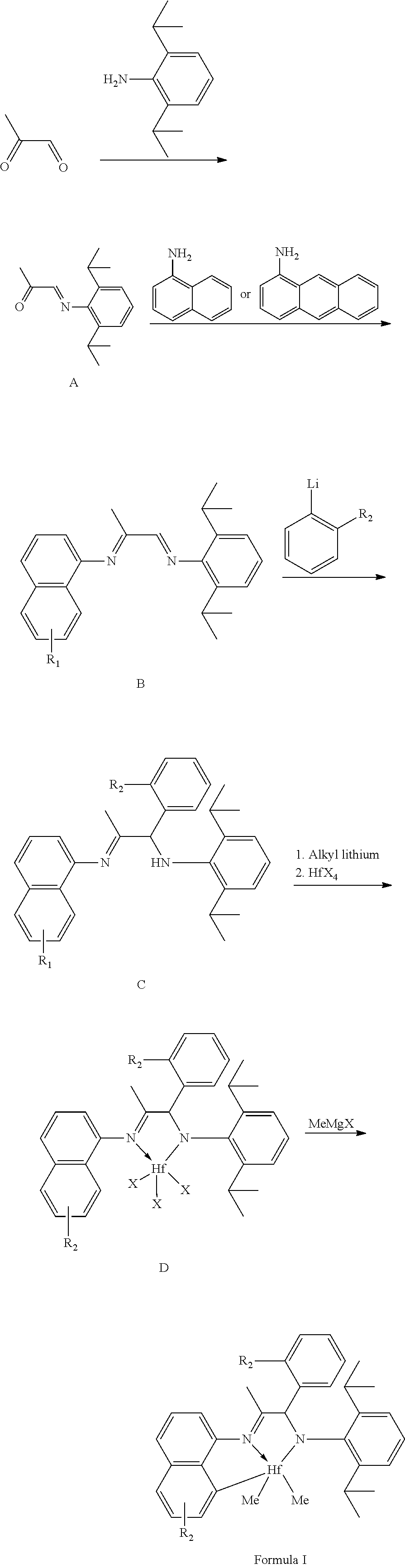
1) reacting methyl glyoxal with 2,6-diisopropylaniline to obtain an intermediate A;
2) reacting the intermediate A with α-naphthylamine or a-anthramine to obtain an intermediate B;
3) reacting the intermediate B with a 2-position R₂-displaced phenyl lithium compound to obtain an intermediate C;
4) reacting the intermediate C with alkyl lithium and hafnium tetrahalide in sequence to obtain an intermediate D;
5) reacting the intermediate D with methylmagnesium halide to obtain the main catalyst represented by Formula I.

3. The preparation method of the main catalyst for preparing poly(4-methyl-1-pentene) according to claim 2, wherein the alkyl lithium in step 4) is n-butyllithium; and/or,
the hafnium tetrahalide in step 4) is hafnium tetrachloride; and/or
the methylmagnesium halide in step 5) is methylmagnesium bromide.

4. A catalyst for preparing poly(4-methyl-1-pentene), wherein the catalyst comprises an activator and the main catalyst according to claim 1.

5. The catalyst according to claim 4, wherein the activator is selected from a composition of trityl tetrakis (pentafluorophenyl) borate and alkyl aluminum.

6. The catalyst according to claim 5, wherein a molar ratio of the trityl tetrakis (pentafluorophenyl) borate to the alkyl aluminum in the composition is 1:(50-300).

7. The catalyst according to claim 6, wherein a molar ratio of the main catalyst to the activator is 1:(1-5).

8. A preparation method of poly(4-methyl-1-pentene), wherein the preparation method comprises:
catalyzing homopolymerization of 4-methyl-1-pentene monomer using the catalyst according to claim 4 to obtain the poly(4-methyl-1-pentene).

9. The preparation method of poly(4-methyl-1-pentene) according to claim 8, wherein the activator is selected from a composition of trityl tetrakis (pentafluorophenyl) borate and alkyl aluminum.

10. The preparation method of poly(4-methyl-1-pentene) according to claim 9, wherein a molar ratio of the trityl tetrakis (pentafluorophenyl) borate to the alkyl aluminum in the composition is 1:(50-300).

11. The preparation method of poly(4-methyl-1-pentene) according to claim 10, wherein a molar ratio of the main catalyst to the activator is 1:(1-5).

12. The preparation method according to claim 8, wherein a molar ratio of the 4-methyl-1-pentene monomer to the catalyst is (100-400,000):1.

13. The preparation method according to claim 9, wherein a molar ratio of the 4-methyl-1-pentene monomer to the catalyst is (100-400,000):1.

14. The preparation method according to claim 10, wherein the molar ratio of the 4-methyl-1-pentene monomer to the catalyst is (100-400,000):1.

15. The preparation method according to claim 11, the molar ratio of the 4-methyl-1-pentene monomer to the catalyst is (100-400,000):1.

16. The preparation method according to claim 12, wherein the molar ratio of the 4-methyl-1-pentene monomer to the catalyst is (10,000-100,000):1.

17. The preparation method according to claim 8, wherein a temperature of the homopolymerization is 20-60° C.

18. The preparation method according to claim 8, wherein the poly(4-methyl-1-pentene) has a weight average molecular weight of ≥500,000, a molecular weight distribution index of ≤4, an isotacticity of ≥95% and a melting temperature of ≥230° C.

19. The preparation method according to claim 12, wherein the poly(4-methyl-1-pentene) has a weight average molecular weight of ≥500,000, a molecular weight distribution index of ≤4, an isotacticity of ≥95% and a melting temperature of ≥230° C.

20. The preparation method according to claim 18, wherein the poly(4-methyl-1-pentene) has the weight average molecular weight of 500,000 to 1,630,000, the molecular weight distribution index of 2.0-4.0, the isotacticity of ≥95% and the melting temperature of 230-240° C.
